(19) United States
(12) Patent Application Publication
(10) Pub. No.: US 2026/0128773 A1
(43) Pub. Date: May 7, 2026

(54) CODEBOOK-BASED PRECODING BASED ON SRS PORT GROUPING

(71) Applicant: InterDigital Patent Holdings, Inc., Wilmington, DE (US)

(72) Inventors: Omid Saatlou, Montreal (CA); Afshin Haghighat, Ile-Bizard (CA); Jonghyun Park, Syosset, NY (US); Mohammad Irfan, Chateauguay (CA); Loic Canonne-Velasquez, Dorval (CA); Virgil Comsa, Montreal (CA); Moon IL Lee, Melville, NY (US)

(73) Assignee: InterDigital Patent Holdings, Inc., Wilmington, DE (US)

(21) Appl. No.: 18/936,560

(22) Filed: Nov. 4, 2024

(51) Int. Cl. H04B 7/06; H04W 24/10

(52) U.S. Cl. CPC H04B 7/0626; H04W 24/10

(57) ABSTRACT

A Wireless Transmit/Receive Unit (WTRU) comprises a processor configured to send a report indicating sounding reference signal (SRS) port grouping capability of the WTRU. The processor is further configured to receive an indication of at least a first SRS port group and a second SRS port group, where each of the first and second SRS port groups is associated with a respective subset of antenna ports. The processor is further configured to estimate a first channel state information (CSI) for the first SRS port group and a second CSI for the second SRS port group, send one or more CSI reports indicating the first estimated CSI and the second estimated CSI, and receive configuration information indicating a codeword (CW) for processing a scheduled transmission using antenna ports of at least one of the first SRS port group or the second SRS port group.

### BACKGROUND

When a network operates in a time division duplex (TDD) mode (e.g., when there is reciprocity between uplink (UL) and downlink (DL) channels), a gNB can calculate DL precoding weights based on a sounding reference signal (SRS) that a user transmits in the UL channel.

### SUMMARY

An example Wireless Transmit/Receive Unit (WTRU) comprising a processor is described. The processor is configured to send a report indicating sounding reference signal (SRS) port grouping capability of the WTRU. The processor is further configured to receive an indication of at least a first SRS port group and a second SRS port group, where each of the first and second SRS port groups is associated with a respective subset of antenna ports. The processor is further configured to estimate a first channel state information (CSI) for the first SRS port group and a second CSI for the second SRS port group. The processor is further configured to send one or more CSI reports indicating the first estimated CSI and the second estimated CSI. The processor is further configured to receive configuration information indicating a codeword (CW) for processing a scheduled transmission using antenna ports of at least one of the first SRS port group or the second SRS port group.

In examples, the processor is further configured to receive an indication to trigger CSI reporting. In examples, the processor is further configured to estimate the first CSI and the second CSI in response to receiving the indication to trigger CSI reporting. In examples, the processor is further configured to estimate the first CSI and the CSI according to a first estimation mode and a second estimation mode. In examples, the processor is further configured to send the one or more CSI reports to indicate, for each of the first and second estimation modes, the first and second CSIs. In examples, the processor, to estimate the first CSI and the second CSI in the first estimation mode, is further configured to determine the first CSI based on a measurement performed on a first subset of the antenna ports corresponding to the first SRS port group. In examples, the processor, to estimate the first CSI and the second CSI in the first estimation mode, is further configured to determine the second CSI based on a measurement performed on a second subset of the antenna ports corresponding to the second SRS port group. In examples, the processor, to send the one or more CSI reports, is further configured to receive an indication to trigger CSI reporting and a priority for CSI reporting associated with each of the first and second SRS port groups. In examples, the processor, to send the one or more CSI reports, is further configured to send a first CSI report corresponding to the first SRS port group prior to a second CSI report corresponding to the second SRS port group based on the first SRS port group having a higher priority than the second SRS port group. In examples, the processor is further configured to receive an indication of a recommended port grouping configuration based on the report indicating that the WTRU supports a plurality of port grouping configurations. In examples, the processor is further configured to select the first and second SRS port groups and the respective subset of the antenna ports of each of the first and second SRS port groups based on the recommended port grouping configuration. In examples, the processor is further configured to determine the respective subsets of the antenna ports assigned to each of the first and second SRS port groups based on the received indication of the first and second SRS port groups. In examples, the processor is further configured to receive, via radio resource control (RRC), the indication of the first and second SRS port groups. In examples, the first and second CSIs include at least one of a precoding matrix indicator (PMI), a rank indicator (RI), a channel quality indicator (CQI), or a lawful interception (LI).

An example method performed by a WTRU is described. The method comprises sending a report indicating SRS port grouping capability of the WTRU. The method further comprises receiving an indication of at least a first SRS port group and a second SRS port group, where each of the first and second SRS port groups is associated with a respective subset of antenna ports. The method further comprises estimating a first CSI for the first SRS port group and a second CSI for the second SRS port group. The method further comprises sending one or more CSI reports indicating the first estimated CSI and the second estimated CSI. The method further comprises receiving configuration information indicating a CW for processing a scheduled transmission using antenna ports of at least one of the first SRS port group or the second SRS port group.

In examples, the method further comprises receiving an indication to trigger CSI reporting. In examples, the method further comprises estimating the first CSI and the second CSI in response to receiving the indication to trigger CSI reporting. In examples, the method further comprises estimating the first CSI and the CSI according to a first estimation mode and a second estimation mode. In examples, the method further comprises sending the one or more CSI reports to indicate, for each of the first and second estimation modes, the first and second CSIs. In examples, estimating the first CSI and the second CSI in the first estimation mode comprises determining the first CSI based on a measurement performed on a first subset of the antenna ports corresponding to the first SRS port group. In examples, estimating the first CSI and the second CSI in the first estimation mode comprises determining the second CSI based on a measurement performed on a second subset of the antenna ports corresponding to the second SRS port group. In examples, sending the one or more CSI reports comprises receiving an indication to trigger CSI reporting and a priority for CSI reporting associated with each of the first and second SRS port groups. In examples, sending the one or more CSI reports comprises sending a first CSI report corresponding to the first SRS port group prior to a second CSI report corresponding to the second SRS port group based on the first SRS port group having a higher priority than the second SRS port group. In examples, the method further comprises receiving an indication of a recommended port grouping configuration based on the report indicating that the WTRU supports a plurality of port grouping configurations. In examples, the method further comprises selecting the first and second SRS port groups and the respective subset of the antenna ports of each of the first and second SRS port groups based on the recommended port grouping configuration. In examples, the method further comprises determining the respective subsets of the antenna ports assigned to each of the first and second SRS port groups based on the received indication of the first and second SRS port groups. In examples, the method further comprises receiving, via RRC, the indication of the first and second SRS port groups. In examples, the first and second CSIs include at least one of a PMI, a RI, a CQI, or a LI.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example process for SRS-based CSI reporting.

FIG. 3 illustrates an example process for Precoding Matrix Indicator (PMI) based CSI reporting.

FIG. 4 illustrates an example process for codebook-based precoding based on SRS port grouping according to an embodiment.

FIG. 5 is a system diagram illustrating an example system configured to determine a number port groups based on a downlink measurement according to an embodiment.

FIG. 6 is a system diagram illustrating an example system configured to determine a port combination based on detected blockage according to an embodiment.

FIG. 7 is a system diagram illustrating an example system configured to determine a SRS port combination based on path loss according to an embodiment.

FIG. 8 is a block diagram illustrating an example of SRS port grouping according to an embodiment.

FIG. 9 is a block diagram illustrating an example of codebook-based downlink (DL) transmission with SRS port grouping according to an embodiment.

### DETAILED DESCRIPTION

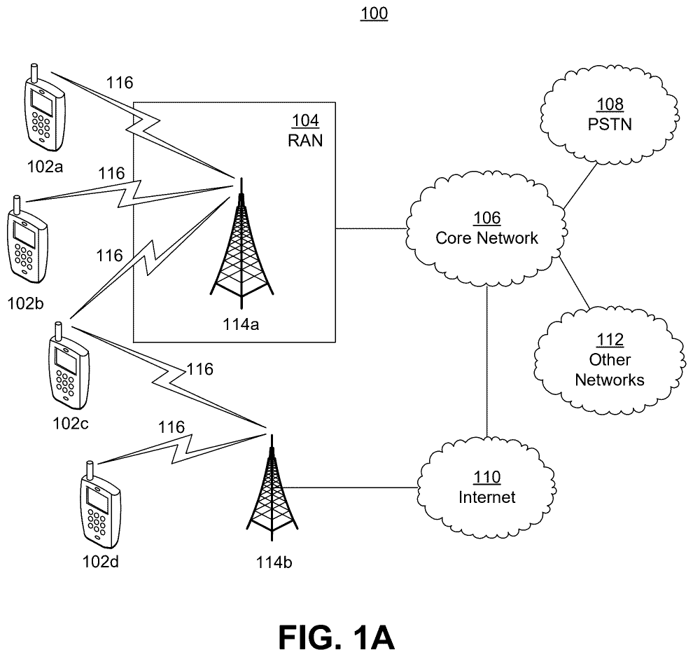

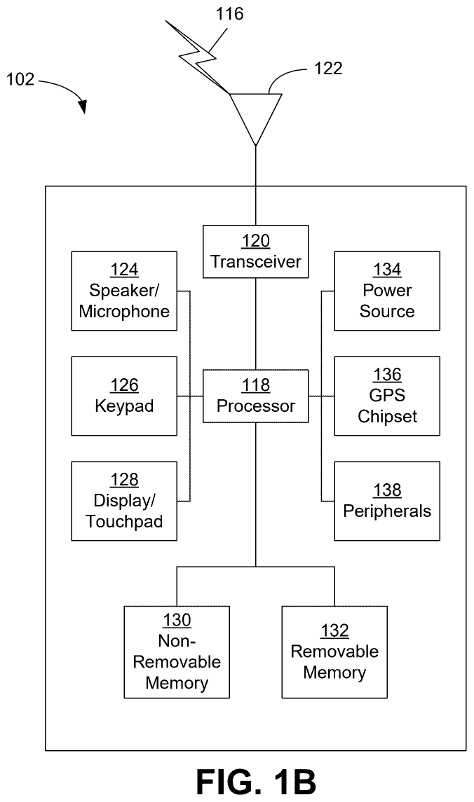

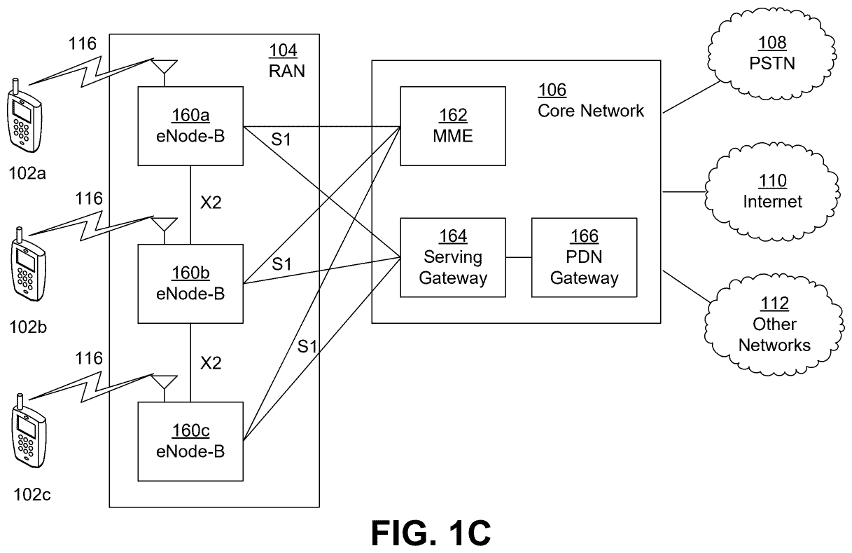

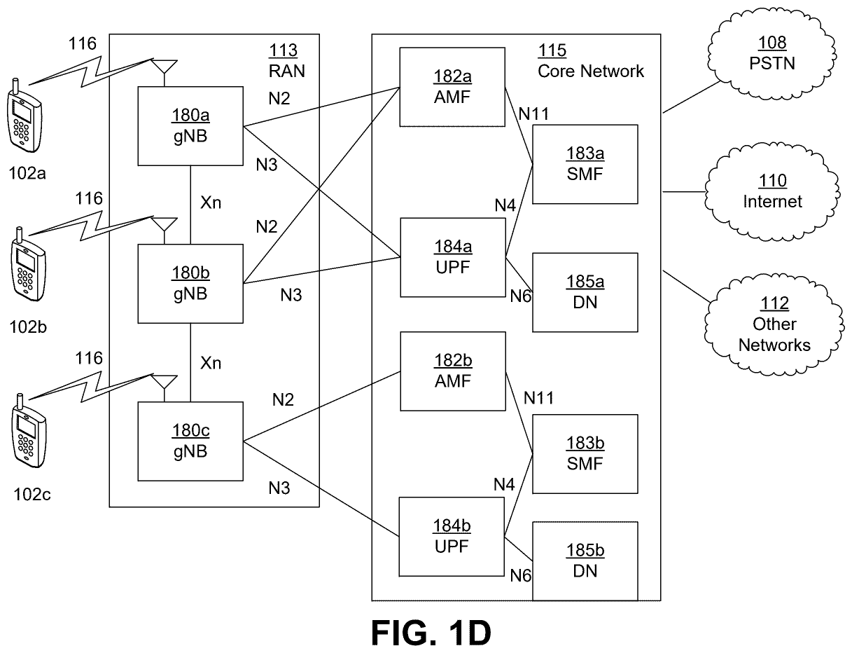

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

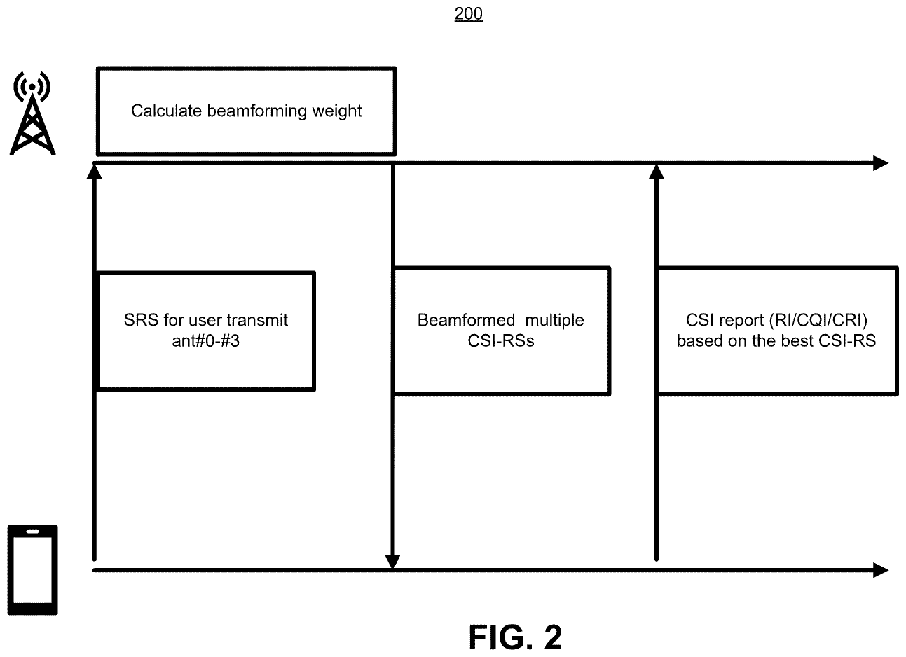

FIG. 2 illustrates an example process 200 for SRS-based CSI reporting. In accordance with the illustrated example, consider a scenario where a network operates under time division duplex (TDD) mode (e.g., when there is reciprocity between the uplink (UL) and downlink (DL) channels). In this example, a network node (e.g., base station, gNB, etc.) may calculate DL precoding weights based on the sounding reference signal (SRS) that a user transmits in UL channel. In this case, the WTRU may be configured (e.g., and/or may be required) to transmit SRS for each of its individual receive antennas as shown in FIG. 2 (e.g., where it is assumed that the WTRU has four antennas).

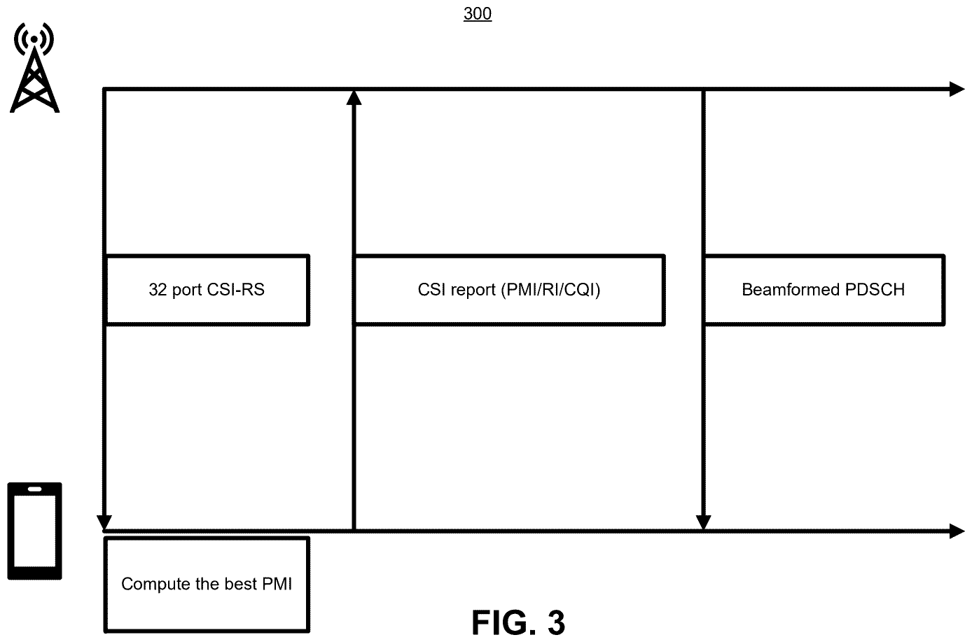

FIG. 3 illustrates an example process 300 for PMI-based CSI reporting. The process 300 represents is an alternative (e.g., PMI-based) method for CSI reporting. In this example, a gNB may transmit CSI reference signal (CSI-RS) resources. For example, the WTRU may calculate CSI parameters (e.g., PMI, channel quality indicator (CQI), rank indicator (RI), etc.). Then, the WTRU may feedback these parameters in order for the gNB to construct DL precoding weights as shown in FIG. 3.

In some wireless network (e.g., NR) implementations, the transmission of two codewords (CWs) with a higher rank than 4 may lead to relatively high DL traffic. In addition, the reception and detection of two DL CWs may be a relatively (e.g., very) complex process. Therefore, the present disclosure provides an example mechanism for low-complexity receivers (e.g., 6/8 Rx) as described herein.

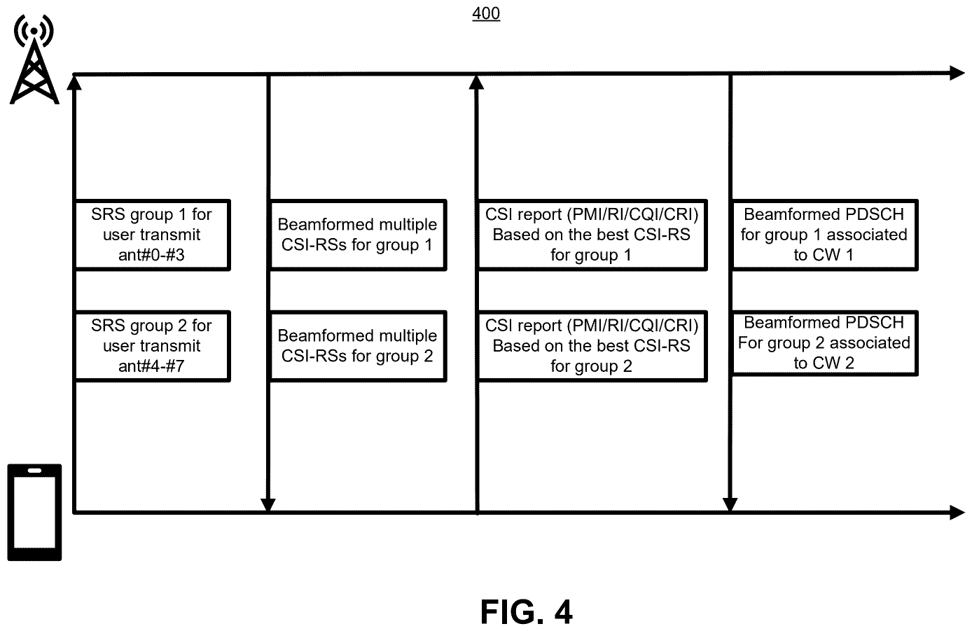

FIG. 4 illustrates an example process 400 for codebook-based precoding based on SRS port grouping according to an embodiment. To support low complexity 6/8 Rx WTRUs, for example, the example process 400 involves SRS port-grouping for reciprocity-based downlink precoding. For example, through SRS port-grouping, the WTRU may determine (e.g., or assume) that the CSI considered by the gNB for transmission of a codeword is based on reception using the same set of antennas that were used for transmission by a specific SRS port-group. As an example of two-codeword transmission, the configured SRS ports may be divided into two port-groups. The gNB may estimate a different CSI for the channel associated to each port-group, and then transmit each codeword according to each CSI as shown in FIG. 4.

SRS port-grouping may also be used for codebook-based downlink precoding. However, to support SRS port-grouping for codebook-based precoding, some mechanisms are needed to resolve any potential ambiguity in association of the reported CSI and scheduled codewords. The present disclosure provides examples that address such issues, such as how a WTRU should estimate, associate, and/or report the CSI parameters (e.g., PMI, RI, CQI, LI, etc.) associated with the SRS port-groups.

Thus, examples described herein may involve SRS port grouping, layer mapping between the port groups, CSI determination based on port groups, and/or priority of port groups for reception.

Within examples described in the present disclosure, SRS port grouping may be employed for codebook-based downlink precoding. Example proposed mechanisms are described herein where the WTRU may estimate and/or report CSIs associated with each port group.

By way of example, the WTRU may report its capability for the support of SRS port-grouping. If the WTRU supports more than one port-grouping configuration, the WTRU may receive an indication of a recommended (e.g., preferred, default, etc.) port-grouping configuration. Based on the reported WTRU capability, the WTRU may receive a value corresponding to a number of port group combinations (e.g., a first port-group and a second port-group, etc.). For example, each port-group may be associated with a subset of antenna ports and each subset may be associated with a codeword. If a transmission (e.g., or codeword) is scheduled, the WTRU may determine a codeword to be processed by antenna ports associated with the first port-group, the second port-group, or both port-groups.

Thus, the present disclosure may provide a solution for high rank complexity reduction that may involve dividing WTRU receive antenna ports into two low dimensional antenna groups for independent CSI calculation and/or Physical Downlink Shared Channel (PDSCH) reception. Thus, example methods described herein may have a relatively lower complexity for high rank DL transmissions (e.g., as compared to traditional methods).

Examples are described herein that relate to (e.g., and/or improve) computation time for staggered CSI-RS resources.

By way of example, a WTRU may report its capability for the support of SRS port-grouping. For example, the WTRU may report its capability for support of N_{G} SRS port-groups, and one or more supported associated (e.g., cases of) port-grouping combinations for the reported N_{G}. For example, an 8Rx WTRU may report a capability of N_{G}=2 port-groups, and the supported combinations of port-grouping for a configured N_{SRS}=8 SRS ports (e.g., 2+6, 4+4, etc.). The WTRU may receive a CSI configuration (e.g., resource, type, etc.).

If the WTRU can support more than one port-grouping configuration, the WTRU may receive an indication (e.g., Downlink Control Information (DCI)) of a recommended (e.g., preferred, default, etc.) port-grouping configuration. For example, the WTRU may determine and/or include the recommended (e.g., best) port-grouping combination in a CSI report. In an example scenario where N_{G}=2 and N_{SRS}=8, the WTRU may determine (e.g., based on a measurement on the configured CSI-RS) that a port-group combination of 2+6 causes less inter port-group interference than other combinations (e.g., 4+4). Thus, the WTRU in this example may indicate 2+6 as the recommended (e.g., preferred) port-grouping.

Based on the reported WTRU capability, the WTRU may receive a value for N_{G} and port-group combination (e.g., SRS configuration via RRC) for grouping of the configured SRS ports. Each port-group may be associated with a subset of antenna ports. For example, the WTRU may receive a configuration of an N_{SRS}-port SRS resource. In this example, the first N_{SRS}/2 of configured ports may correspond to the first SRS port group and the remaining ports may correspond to second SRS port group.

The WTRU may receive an indication (e.g., a DCI) to trigger a CSI report. In response to receiving the indication to trigger the CSI report, the WTRU may estimate N_{G} CSIs based on two modes of estimation. In a first mode of estimation, the WTRU may estimate N_{G} CSIs where each CSI (e.g., PMI, RI, CQI, LI) is determined based on a measurement performed only on the antenna ports associated with the corresponding port-groups. For example, the WTRU may determine a first PMI (e.g., PMI1) based on (e.g., or only based on) measurements performed on antenna ports associated with the first port group. Furthermore, the WTRU may determine a second PMI (e.g., PMI2) based on (e.g., or only based on) measurements performed on antenna ports associated with the second port group. In a second mode of estimation, the WTRU may estimate two CSIs for the two port groups, where each CSI (e.g., PMI RI, CQI, LI) is determined based on a joint measurement on (e.g., all) antenna ports associated with both port-groups. For example, to consider inter port-group interference, the WTRU may determine PMI1 and PMI2 based on a joint measurement performed on antenna ports of both port-groups.

Alternatively or additionally, in response to receiving the indication to trigger the CSI report, the WTRU may report N_{G} CSIs for each mode of estimation. For example, the WTRU may send one or more CSI reports indicating a first CSI for the first port group, a second CSI for the second port group, etc. If N_{G} CSIs are reported in different CSI reports, the CSI report associated with a designated/configured/indicated port-group (e.g., first port-group) may be assigned a higher priority compared to the second group. For example, if the WTRU may receive an indication of a priority of each port group.

The WTRU may receive an indication (e.g., a scheduling DCI) of a scheduled transmission. Based on the received indication, the WTRU may determine associated antenna ports for reception of the scheduled transmission. For example, the WTRU may determine a codeword to be processed by antenna ports associated with the first port group, the second port group, and/or both port groups. Thus, in various example configurations, a given codeword can be used for processing one port group or multiple port groups.

Examples are described herein for codebook-based precoding based on SRS port grouping. In an example solution, the WTRU may employ SRS port grouping for codebook-based downlink precoding. A proposed example mechanism is described herein to estimate and/or report CSIs associated with port groups.

Examples WTRU capabilities for the support of SRS port grouping are described herein. A WTRU may report its capability for the support of SRS port-grouping. For example, a WTRU may report its capability for support of N_{G} SRS port-groups. The WTRU may also report the supported associated cases of port grouping for the reported N_{G}. For example, an 8Rx WTRU may report a capability of N_{G}=2 port-groups, and the supported combinations of port-grouping for a configured N_{SRS}=8 SRS ports (e.g., 2+6, 4+4, etc.).

By way of example, a WTRU with N_{RX} receive antennas may be configured with one or more SRS resources across one or more SRS resource sets to support N_{SRS}=N_{RX} ports. In a solution, the WTRU may report its capability for SRS port-grouping based on its frontend radio frequency (RF) structure. As such, the WTRU may report N_{G} as the number of port-groups where each port-group includes a non-overlapping subset of SRS ports. The WTRU may also report that the total number of SRS ports across the port-groups equals N_{SRS}. The number of SRS ports per port-group may or may not be balanced. In a WTRU with N_{RX} receive antennas, each SRS port-group may be associated with a specific subset of SRS ports. Therefore, from gNB perspective, downlink CSI observed by a specific subset of the receive antennas may be derived from the uplink channel observed by the gNB based on the SRS transmission from the same subset of the antennas.

In an exemplary solution, an 8RX WTRU may have the capability of SRS port-grouping with N_{G}=2, where a first 4 SRS ports may be associated with a first 4 subset of the 8 receive antennas, and a second 4 SRS ports may be associated with a second 4 subset of the 8 receive antennas.

In an example, depending on WTRU capability and other operational parameters (e.g., blockage, etc.), a WTRU may report one or more SRS port grouping configurations (e.g., options). For example, an 8RX WTRU may report more than one combination of SRS ports for port grouping. For example, for a reported capability of N_{G}=2, the WTRU may report two options of 2+6 and 4+4 port-grouping, where each case may be configured by gNB for a different downlink transmission scenario.

Hence in a solution, the information related to SRS port-grouping may be based on two levels or types of indication. As an example level or type of indication, the WTRU may be configured for reporting one or more values for the supported cases of port grouping (e.g., N_{G}). For example, in a case where N_{SRS}=N_{RX}=8, the WTRU may report more than one value for port-grouping (e.g., N_{G}={2, 4}). As another example level or type of indication, the WTRU may be configured for reporting one or more combinations of ports for the supported cases of port-grouping. For example, in a case where N_{SRS}=N_{RX}=8, the WTRU may report more than one combination of ports for each of the reported N_{G}={2, 4}. In an exemplary solution, for N_{G}=2, the WTRU may support two configurations of 2+6 and 4+4 port-grouping. Whereas, for N_{G}=4, the WTRU may support (e.g., only support) the configuration of 2+2+2+2 port grouping.

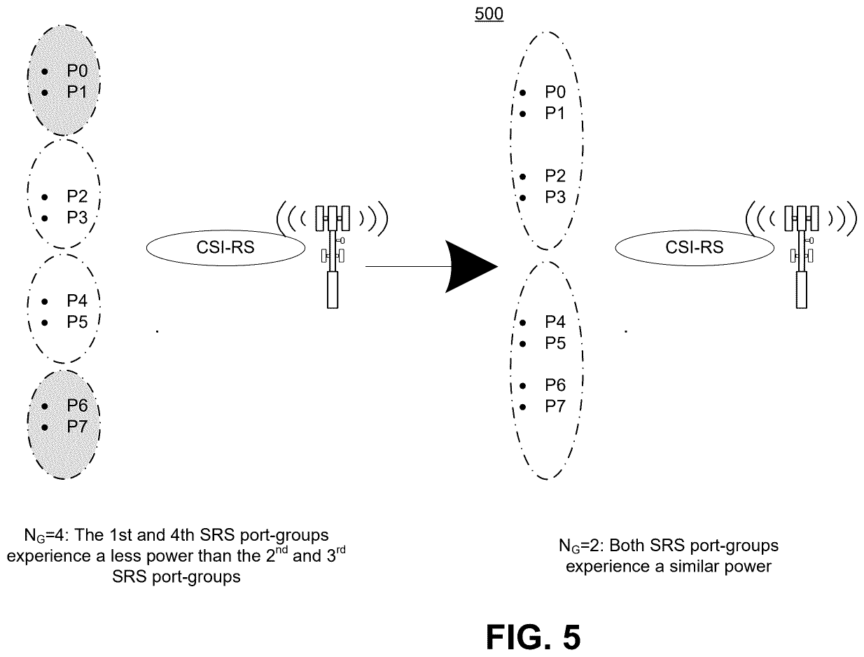

FIG. 5 is a system diagram illustrating an example system 500 configured to determine a number port groups based on a downlink measurement according to an embodiment. In the scenario of the illustrated example, the WTRU may support more than one port-grouping or a combination of ports. Thus, in this example, the WTRU may indicate a recommended (e.g., preferred, default, optimized, best, etc.) port grouping and/or port combination.

For instance, as shown in FIG. 5, the WTRU may be configured with one or more downlink reference signals (e.g., a CSI-RS, Synchronization Signal Block (SSB), etc.) that may be used for determination of port-grouping. Once the WTRU is configured with N_{SRS} ports for port-grouping, for each hypothesis of supported N_{G} values, the WTRU may perform a measurement (e.g., Reference Signal Received Power (RSRP), rank, etc.) to determine and/or report a preferred N_{G} value. Further, if the WTRU can support more than one port combination, then for each hypothesis of supported N_{G} values, the WTRU may also determine and/or report a recommended (e.g., preferred) port combination for the recommended (e.g., preferred) N_{G} value. For example, a 6RX WTRU configured with N_{SRS}=6 ports, may receive a DCI to perform an aperiodic CSI measurement for N_{G} and port combination determination. Based on the measurement, the WTRU may indicate an N_{G}=2, with an unbalanced port combination of 2+4. FIG. 5 demonstrates an exemplary case, where the WTRU may determine the number of port groups based on having a similar power measured across the antenna ports of the port groups.

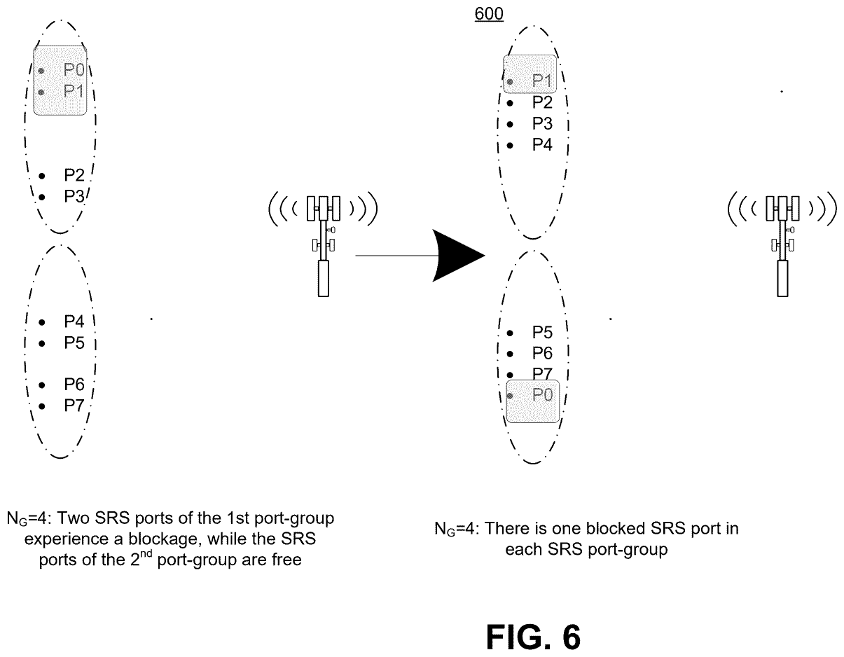

FIG. 6 is a system diagram illustrating an example system 600 configured to determine a port combination based on detected blockage according to an embodiment. Thus, the example system 600 may represent an alternative or additional exemplary solution for determining the port groups and/or port combinations. In this example, the WTRU may determine a recommended (e.g., preferred) port-grouping and/or combination of ports based on occurrence of a blockage (e.g., network blockage). The blockage may be due to WTRU hand gripping, foliage, and/or other (e.g., similar) channel imperfections. In an example, the WTRU may be equipped with proximity sensors configured to detect proximity of human body to one or more WTRU antennas. If the WTRU determines blockage of one or more of antennas associated with the configured SRS ports, the WTRU may send an indication to the network node (e.g., base station, gNB). For example, the indication may be a basic report to gNB for requesting a reconfiguration of N_{G}. Alternatively or additionally, the report may indicate a different (e.g., new) recommended (e.g., preferred) N_{G} and/or port combination. To report, the WTRU may use a preconfigured scheduling request (SR) or include the indication in an ongoing CSI report. In the example of FIG. 6, the WTRU may determine the combination of SRS ports within each port group based on a detected blockage.

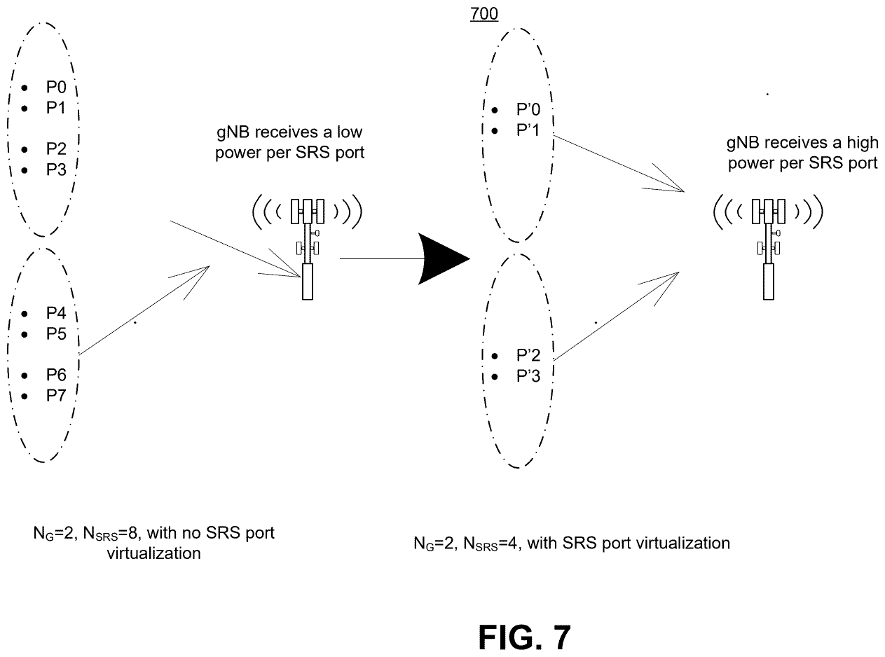

FIG. 7 is a system diagram illustrating an example system 700 configured to determine a SRS port combination based on path loss according to an embodiment. Thus, the example system 700 provides an alternative solution for determining SRS port combination(s). In this example, if the WTRU can support SRS port virtualization to boost uplink transmit power, the WTRU may determine a preferred N_{SRS}, port-grouping, and/or combination of ports based on a measured pathloss. In a solution, the WTRU may measure the downlink pathloss and determine a recommended (e.g., preferred) port-grouping if the measured pathloss meets a configured threshold. For example, if the WTRU is configured with N_{SRS} SRS ports and the measured pathloss is below a configured threshold, the WTRU may recommend a different N_{SRS} (e.g., N_{SRS}(new)<N_{SRS} ports), a different N_{G} (e.g., N_{G}(new)≤N_{G}), and/or a different port combination. For instance, in the example shown in FIG. 7, if a WTRU with SRS port virtualization is initially configured with N_{SRS}=8 and N_{G}=2, and the measured path loss is below a threshold, the WTRU may report a preferred N_{SRS}=4 and N_{G}=2, e.g., which may allow power combining through SRS port virtualization for better coverage.

Alternatively or additionally, the WTRU may report the number of SRS port-groups, i.e., N_{G}, based on the SRS resources for antenna switch (e.g., RF switching circuitry implementation) and/or channel orthogonality.

As an example for reporting based on antenna switching SRS resources, the WTRU may determine N_{G} based on the WTRU capability for SRS switching. If supportedSRS-TxPortSwitch=1T2R, for example, the WTRU may determine that a maximum of two SRS ResourceSet can be handled by the WTRU, and that each ResourceSet may have two SRS Resources transmitting at different symbols. Thus, the WTRU may partition the ports of each symbol as a group and determine the number of SRS port-group, i.e., N_{G}. This partitioning may be based on WTRU capability for switching. In another example, if supportedSRS-TxPortSwitch=2T4R, the WTRU may determine that a maximum one SRS ResourceSet can be handled by the WTRU and that the ResourceSet may have four SRS Resources transmitting at different symbols. For example, each SRS Resource in a ResourceSet may include (e.g., or consist of) a single SRS port and the SRS port of each resource may be associated with a different WTRU antenna port. Then, based on this WTRU capability, the WTRU may determine the number of SRS port-group, i.e., N_{G}. In yet another example, if supportedSRS-TxPortSwitch=1T1R, or 2T=2R, or 4T=4R, the WTRU may determine that a maximum two SRS ResourceSet can be handled by the WTRU. Thus, in these cases, the WTRU may have more freedom (e.g., or may generate more than one possible port grouping configuration) to partition the SRS port grouping(s) and/or to determine the number of SRS port group(s), i.e., N_{G}.

As an example for reporting based on orthogonality of the channels, the WTRU may partition the ports based on channel orthogonality of the Rx ports and may determine N_{G} accordingly. For instance, the WTRU may select two port groups including the most semi-orthogonal channels in each group. To this end, additionally or alternatively, the WTRU may partition the groups based on a SRS switching limitation (e.g., supportedSRS-TxPortSwitch). In a solution, if supportedSRS-TxPortSwitch=1T2R, the WTRU may select 2 semi-orthogonal ports in one group. With this strategy, the WTRU may mitigate interference between the two groups, for example. The WTRU may perform semi-orthogonal ports selection based on inner products of ports channel, for example. In one solution, based on WTRU capability, a transmit antenna may switch to 2 or 4 receive antennas. If the WTRU has the capability to select the receive antennas for switching, the WTRU may select the ports with minimum inner products in a group. In this example, the WTRU may first select a random port for a group and then select other ports in that group which offer a minimum inner product among the other possible ports. In this solution, semi-orthogonality of ports' channel is corresponding to the minimum inner products of ports' channel. In another solution, if there is no SRS switching limitation (e.g., supportedSRS-TxPortSwitch=1T1R), then the WTRU may determine N_{G} based on the minimum inner products of ports channel among various (e.g., all) possibilities of SRS grouping. For example, the WTRU may consider various (e.g., all) grouping possibilities (e.g., N_{G}=1, 2, 3, 4, . . . , 8) to determine (e.g., estimate) and/or report which value of N_{G} offers a minimum interference among the groups.

Examples are described herein for mapping layers between port groups. For example, a WTRU may receive a CSI configuration (e.g., resource, type, etc.). If the WTRU can support more than one port grouping configurations, the WTRU may receive an indication (e.g., a DCI) of a recommended (e.g., preferred) port grouping configuration. For example, the WTRU may determine and/or include the recommended (e.g., best) port-grouping combination in a CSI report. In an example, for the case of N_{G}=2 with N_{SRS}=8, the WTRU may determine (e.g., based on a measurement on the configured CSI-RS) that a port-group combination of 2+6 causes a less inter port-group interference than other combinations. Thus, in this example, the WTRU may indicate 2+6 as the preferred port-grouping. Based on the reported WTRU capability, the WTRU may receive a value for N_{G} and/or port-group combination (e.g., SRS configuration via RRC) for grouping of the configured SRS ports, where each port-group is associated with a subset of antenna ports. For example, the WTRU may receive a configuration of an N_{SRS}-port SRS resource, where the first N_{SRS}/2 of configured ports are the first SRS port-group, and the remaining ports are the second port-group.

Example configuration parameters for SRS port grouping are described herein. In an example solution, the WTRU may receive configuration parameters for SRS port-grouping, port-group-specific SRS transmission parameters, and/or CSI/beam measurement and reporting. At least one of the configuration parameters may be associated with a SRS port-group (e.g., of N_{G} SRS port groups) based on the reported WTRU capability on SRS port-grouping. Configuration parameters for CSI/beam measurement and/or reporting may comprise, for example, one or more measurement resources or resource types associated with at least one SRS port-group. In an example, if a measurement resource (e.g., CSI-RS resource) or resource type is associated with a first SRS port-group, the WTRU may be configured to measure the measurement resource by using one or more receive antennas (e.g., transmit antennas, receive/transmit antennas, antenna ports) that have been used (e.g., most recently) for SRS transmissions associated with the first SRS port-group.

Examples are described herein for port-group-specific SRS transmissions. Configuration parameters for the SRS port-grouping and/or the port-group-specific SRS transmission parameters may comprise an association, mapping, or linkage parameter (e.g., among value(s) for N_{G}) and one or more SRS ports in an SRS resource or SRS resource set. The WTRU may determine that the SRS resource (e.g., or set of SRS resources) is associated with which SRS port-group and/or which subset of antennas ports (e.g., receive/transmit antennas). In an example, if the association, mapping or linkage parameter indicates a second SRS port-group for the SRS resource (or set), the WTRU may transmit SRS(s) of the SRS resource (or set) by using the subset of the antenna ports (e.g., receive/transmit antennas) of the WTRU that correspond to the second SRS port-group.

The association, mapping or linkage parameter may indicate a port-group combination in an SRS resource (e.g., or set of SRS resources). In an example, the WTRU may determine that the indicated port-group combination for the N_{SRS}-port SRS resource (e.g., or set of SRS resources) indicates the first N_{SRS}/2 SRS ports in the SRS resource (e.g., or set of SRS resources) are associated (e.g., mapped, linked) with the first SRS port-group and the remaining ports are associated with the second SRS port-group. The WTRU may transmit SRS(s) of the SRS resource (e.g., or set of SRS resources) by using the first N_{SRS}/2 SRS ports corresponding to the first SRS port-group and by using (e.g., at the same time) the remaining ports corresponding to the second SRS port-group.

Examples are described herein for port-group-specific CSI/beam measurement and reporting. Based on the configuration parameters for the CSI/beam measurement and reporting, the WTRU may be configured to determine and report one or more preferred (e.g., best, based on highest measured quality metric, etc.) beam(s), CSI component(s), and/or measured quality metric(s), based on the associated SRS port-group(s). In an example, the WTRU may determine and report the (e.g., M-th) best port-grouping combination in a beam or CSI report (instance). The parameter of M may be configured (e.g., by RRC) and/or indicated by medium access control-control element (MAC-CE) and/or DCI. If M=1, the WTRU may determine and report the best port-grouping combination along with recommended (e.g., preferred) beam(s), CSI component(s), and/or measured quality metric(s) based on the recommended (e.g., best) port-grouping combination in a beam or CSI report (e.g., CSI report instance). If M=2, the WTRU may determine and report a second (e.g., the second-best) port-grouping combination along with preferred beam(s), CSI component(s), and/or measured quality metric(s) based on the second (e.g., second-best) port-grouping combination in a beam or CSI report (e.g., CSI report instance). In another example, if M=2, the WTRU may determine that (e.g., or it may imply) both M=1 and M=2, where the WTRU may determine and report the first and second (e.g., first best and second best) port-grouping combinations along with preferred beams, CSI components, and/or measured quality metrics based on the first and second (e.g., first and second best) port-grouping combinations in a beam or CSI report (e.g., CSI report instance).

Examples are described herein for port-group-specific data transmission (e.g., Physical Uplink Shared Channel (PUSCH)) and reception (e.g., Physical Downlink Shared Channel (PDSCH)). In a solution (e.g., based on condition that a WTRU sent its capability reporting contents indicating support of more than one port-grouping configurations), the WTRU may receive an indication, e.g., via a DCI, to indicate the preferred (e.g., applicable, explicitly-indicated, etc.) port-grouping configuration. The indication may be associated with data scheduling (e.g., grant). The indication, e.g., may be via a DL-DCI scheduling a PDSCH or a UL-DCI scheduling a PUSCH, aperiodic beam or CSI measurement and reporting trigger, an activation command activating a semi-persistent-scheduling PDSCH (SPS-PDSCH) or a configured-grant PUSCH (CG-PUSCH), and so on.

In an example, the WTRU may determine and include the (e.g., best) port-grouping combination in a beam or CSI report. For the case of N_{G}=2 with N_{SRS}=8, for example, the WTRU may determine (e.g., based on a measurement on the configured CSI-RS) that a port-group combination of 2+6 causes less inter port-group interference than other combinations (e.g., 6+2, 4+4, etc.). Based on the determination, the WTRU may report (e.g., indicate) 2+6 as the (e.g., preferred) port-grouping (e.g., along with preferred beam(s), CSI component(s), and/or measured quality metric(s) based on the port-group combination of 2+6).

The WTRU may receive an implicit or explicit layer mapping indication (e.g., and/or codeword (CW) indication) for a scheduled PDSCH and/or PUSCH. In an example, the WTRU may receive a DCI (e.g., DL-DCI, PDSCH-scheduling grant) indicating a PDSCH to be received where the layer mapping for Demodulation Reference Signal (DMRS) ports associated with the scheduled PDSCH may be split across different SRS port-groups. In an example, the WTRU may receive a DCI (e.g., UL-DCI, PUSCH-scheduling grant) indicating a PUSCH to be transmitted where the layer mapping for DMRS ports associated with the scheduled PUSCH may be split across different SRS port-groups. In an example, the explicit layer mapping indication may be indicated by a new DCI field (e.g., SRS port-group indicator (SPGI)) or an existing DCI field with a re-interpretation of the DCI field).

In an example, the WTRU may determine, based on the DCI, that the whole scheduled layers (e.g., DMRS ports, 6 layers) is associated with the first SRS port-group. Based on the determination, the WTRU may receive a PDSCH (or transmit a PUSCH) by using first one or more receive (e.g., or transmit) antennas (e.g., receive/transmit antennas, antenna ports) that have been used (e.g., most recently) for SRS transmissions associated with the first SRS port-group.

In an example, the WTRU may determine based on the DCI the whole scheduled layers (e.g., DMRS ports, 8 layers) is associated with the second SRS port-group. Based on the determination, the WTRU may receive a PDSCH (or transmit a PUSCH) by using second one or more receive (e.g., or transmit) antennas (e.g., receive/transmit antennas, antenna ports) that have been used (e.g., most recently) for SRS transmissions associated with the second SRS port-group.

In an example, the WTRU may determine based on the DCI a first part of the scheduled layers (e.g., DMRS ports, 4 layers) is associated with the first SRS port-group and a second part of the scheduled layers (e.g., DMRS ports, 2 layers) is associated with the second SRS port-group. Based on the determination, the WTRU may receive a (e.g., total of 6 layer-scheduled) PDSCH (e.g., or may transmit a PUSCH). To do so, the WTRU may use first one or more receive (e.g., or transmit) antennas (e.g., receive/transmit antennas, antenna ports) that have been used (e.g., most recently) for SRS transmissions associated with the first SRS port-group. Furthermore, (e.g., at the same time) the WTRU may use second one or more receive (e.g., or transmit) antennas (e.g., receive/transmit antennas, antenna ports) that have been used (e.g., most recently) for SRS transmissions associated with the second SRS port-group.

As the WTRU reports its port grouping capabilities N_{G} and group combinations, the network may configure the WTRU via RRC with SRS resources that are associated with its reported port-group respectively.

The port-grouping may be associated with specific antenna panels individually as the intended MIMO layers reception of different layers may be split. To facilitate the channel sounding from the base station (e.g., network node, gNB, etc.) perspective, the WTRU may transmit appropriate SRS sounding sequences/resources from these different antenna panels.

Since the SRS port grouping and selected antennas may be unbalanced (e.g., the combinations 2+4, 4+2) if the legacy rule is followed (e.g., equal power spread along the allocated ports), the WTRU may allocate power differently to adjust (e.g., as such) the power density of the SRS to achieve a similar UL coverage.

In one scenario, the WTRU may measure the CSI-RS or SSB for path loss determination separately for each antenna panel group. This may result in different pathloss measurements (e.g., PL1 and PL2 if two antenna groups are defined), due to a possible different orientation and/or shadowing per antenna panel.

In one solution, the WTRU may apply these PL1 and PL2 for SRS transmissions power allocations, respectively, so as to spread the resulted power equally over the respective defined port group (e.g., as such similar uplink coverage is perceived by the base station in both transmissions).

Alternatively, the WTRU may measure one pathloss (PL) using (e.g., all) panels and combine the received receive signal (RS) power. For the unbalanced port grouping cases, the WTRU may determine PL1 and PL2 (e.g., if two port groups are defined) by scaling the PL according to the port grouping ratio. For example, a 2:4 port split may lead to a 3 dB PL1 (e.g., 2 ports) versus PL2 (e.g., 4 ports). The compensated PL may be applied respectively to the SRS transmission pertaining to the defined port group number.

In terms of scheduling, since there are N_{G} port groups declared by the WTRU in its capabilities, the network may schedule periodic SRS transmissions separately for each SRS port group respectively. Thus, for aperiodic SRS transmissions for example, the WTRU may infer the corresponding SRS transmissions over associated ports based on RRC configured SRS resources per declared group. Alternatively, for example, the network may directly indicate in a DCI the SRS resource to be used for the scheduled transmission. Thus, in this example, the WTRU may use the corresponding antenna panel(s) based on its declared capabilities.

For periodic SRS, the WTRU may alternate the SRS transmissions over the associated port groups based on an odd/even slot number rule. Alternatively, the WTRU periodic SRS transmissions may be RRC configured for different port groups with a slot based specific rule per SRS configured resource.

If type 3 Power Headroom Report (PHR) is configured by the network for reporting (e.g., which is related to the SRS transmissions, power headroom, etc.), the WTRU may compute the PHR based on the last measured PL for the associated port group from the last SRS transmission on that group. Alternatively, the WTRU may report the highest PHR between the computed PHRs over all declared N_{G} groups, and may signal an indication of the port group. Alternatively, the WTRU may signal PHR for all port groups in a multigroup PHR type 3, e.g., where the values may be quantized completely in absolute values per port group or have a one absolute value for the first port group and add delta values for the rest of groups to be reported. In an another solution, when type 3 PHR is scheduled (e.g., or triggered by one port group PL measurement), the WTRU may signal a real PHR for the triggering port group and may add a virtual PHR for the secondary port groups that where not part of the triggering event. The virtual PHR calculation, for example, may be based on the measured PL on associated antenna panel(s) and port(s), and may follow the virtual PHR rules for the rest of the parameters.

In another solution, the WTRU may receive an indication for layer mapping between the groups.

The layer mapping may be based on maximum throughput between the layers of the two groups per each WTRU. For example, the gNB may estimate the channel of all ports by receiving two SRSs from the groups. Then, the gNB may compute the throughput of all possible two groups. For example, if 8 ports are available at the WTRU, the gNB may compute the throughput of all possible layer mapping(s) between the two groups, i.e., 1+7, 2+6, 3+5 and 4+4. Then, the gNB may determine which layer mapping between two groups offers the maximum throughput. Then, the WTRU may receive an indication of the layers between the two groups associated with the maximum throughput.

Alternatively or additionally, the layer mapping may be based on maximum sum throughput among all the layers of all scheduled WTRUs. For example, the gNB may estimate the channel of all ports by receiving the two SRSs from the respective port groups of each WTRU. Then, the gNB may compute the throughput of all possible two groups (e.g., two group combinations) for each WTRU. For example, if 8 ports are available at each WTRU, the gNB may compute the throughput of all possible layer mapping(s) between two groups for each WTRU, i.e., 1+7, 2+6, 3+5 and 4+4 among all the scheduled WTRUs. Then, the gNB may determine (e.g., find) which layer mapping between two groups of each WTRU offers a maximum sum throughput among all the layers of all scheduled WTRUs. Then, each WTRU may may receive an indication of the layers between the two groups with the maximum sum throughput.

Alternatively or additionally, the layer mapping may be based on minimum interference between the layers of the two groups per each WTRU. For example, the gNB may estimate the channel of all ports by receiving the two SRSs from the port groups. Then, the gNB may compute the interference of all possible two groups (e.g, two group combinations). For example, if 8 ports are available at the WTRU, the gNB may compute the throughput of all possible layer mapping(s) between two groups, i.e., 1+7, 2+6, 3+5, and 4+4. Then, the gNB may determine (e.g., find) that which layer mapping between two groups offers the minimum interference between two groups. Then, the WTRU may receive an indication of the layers between the two groups with the minimum interference.

Alternatively or additionally, the layer mapping may be minimum interference among all the layers of all scheduled WTRUs. For example, the gNB may estimate the channel of all ports by receiving the two SRSs from the port groups of each WTRU. Then, the gNB may compute the interference of all possible two groups (e.g., possible two group combinations) for each WTRU. For example, if 8 ports are available at each WTRU, the gNB may compute the interference of all possible layer mapping(s) between the two port groups (e.g., two port group combinations) for each WTRU, i.e., 1+7, 2+6, 3+5, and 4+4, among all the scheduled WTRUs. Then, the gNB may determine (e.g., find) which layer mapping between two groups of each WTRU offers the minimum interference among all the layers of all scheduled WTRUs. Then, each WTRU may receive an indication of the layers between the two groups associated with the minimum interference.

In another solution, if a WTRU receives an indication for layer mapping and there is an orphan layer in one of the port groups, the WTRU may determine layer group 1 for dominant layers and layer group 2 with less dominant layers groups. Alternatively or additionally, the WTRU may determine the strongest layers for the orphan group.

Examples are described herein for CSI reporting based on port grouping. By way of example, when the WTRU receives an indication (e.g., a DCI) to trigger a CSI report, the WTRU may estimate N_{G} CSIs based on two modes of estimation. In a first mode of estimation, the WTRU may estimate N_{G} CSIs, where each CSI (e.g., PMI, RI, CQI, LI) is determined based on a measurement performed (e.g., only) on the antenna ports associated to the corresponding port-groups. For example, the WTRU may determine PMI-1 based on (e.g., only based on) measurements performed on antenna ports associated with the first port-group. Similarly, WTRU may determine PMI-1 based on (e.g., only based on) measurements performed on antenna ports associated with the second port-group. In a second mode of estimation, the WTRU may estimate two CSIs, where each CSI (e.g., PMI RI, CQI, LI) is determined based on a joint measurement on all antenna ports associated with the first and second port-groups. For example, to account for inter port-group interference, the WTRU may determine PMI-1 and PMI-2 based on a joint measurement performed on antenna ports associated with both port-groups.

Alternatively or additionally, the WTRU may report N_{G} CSIs for each mode of estimation. If N_{G} CSIs are reported in different CSI reports, the CSI report associated with a designated/configured/indicated port-group (e.g., first port-group) may have (e.g., or may be assigned) a higher priority than the CSI report associated with the second port group.

Example CSI configurations are described herein. A WTRU may semi-statically or dynamically (e.g., by RRC, MAC-CE, and/or DCI) receive a CSI configuration. For example, the WTRU may be configured to receive a first CSI-RS resource(s) associated with a first CSI-RS resource set (e.g., for CSI determination for a first SRS port group) and a second CSI-RS resource(s) in a first CSI-RS resource set (e.g., for CSI determination for a second SRS port group). Alternatively or additionally, the WTRU may be configured to receive first set of CSI-RS resource(s) associated with a first CSI-RS resource set (e.g., for CSI determination for a first SRS port group) and a second set of CSI-RS resource(s) associated with a second CSI-RS resource set (e.g., for CSI determination for a second SRS port group). Alternatively or additionally, the WTRU may be configured to receive a first CSI-RS resource(s) associated with a first CSI-RS resource set (e.g., for CSI determination for a first SRS port group and a second SRS port group).

Examples are described herein for primary groups. One or more of the SRS port groups may be classified as a primary SRS port group(s). The WTRU may determine (e.g., implicitly) the primary group(s) based on a past or current CSI reported by the WTRU. For example, an SRS port group with the highest CQI, highest rank indicator (RI), or strongest rank, RSRP and/or SINR may be classified as the primary SRS port group. Alternatively or additionally, a gNB may send to the WTRU a semi-static or dynamic indication of a primary SRS port group. Additionally or alternatively, a SRS port group with the largest number of SRS ports or the smallest number of SRS ports may be classified as the primary SRS port group. Additionally or alternatively, a SRS port group associated with a CSI-RS resource with the highest or smallest ID may be classified as a primary group. Additionally or alternatively, the WTRU may use CSI-RS resources associated with SRS port groups other than the primary group as interference measurement resources to measure, determine or predict interference caused by other groups to the primary group. Additionally or alternatively, the WTRU may use the CSI-RS resources associated with the primary group as interference measurement resources to measure, determine or predict interference caused by primary group to other groups.

The primary group(s) may be associated with a primary codeword or a first codeword. The primary codeword may be used for reception of a specific traffic type, e.g., the primary codeword may contain data for a low latency and/or high reliability communication (e.g., ultra-reliable low latency (URLLC) communication), or for high speed (e.g., enhanced Mobile Broadband (eMBB)).

Examples are described herein for CSI determination. The WTRU may determine a CSI for one or more of the SRS port groups. For example, the WTRU may determine PMI, RI, CQI, LI for a first SRS port group and PMI, RI, and CQI for a second SRS port group.

The WTRU may determine a CSI for an SRS port group based on the CSI-RS resource associated with the SRS port group. For example, an SRS port group may be associated with a first set of SRS ports and a first CSI-RS resource(s). The WTRU may determine a CSI for the SRS port group based on the first CSI-RS resource received by the first set of SRS ports. For example, the determined CSI for a first SRS port group is without considering the interference between the first and the second SRS port groups.

The WTRU may determine a CSI for a first SRS port group considering interference caused to the first SRS port group from the second SRS port group. For example, a first SRS port group may be associated with a first set of SRS ports and a first CSI-RS resource or a first CSI-RS resource set. A second SRS port group is associated with a second set of SRS port groups and a second set CSI-RS resource or a second CSI-RS resource set. The WTRU may determine a CSI for the first SRS port group considering interference by the second SRS port group.

The WTRU may use a first CSI-RS resource or a first CSI-RS resource set associated with a first SRS port group as an interference measurement resource for the second SRS port group. For example, the WTRU may determine interference caused by the first SRS port group to the second SRS port group based on the CSI-RS resource(s) and/or the CSI-RS resource set associated with the first SRS port group. For example, when the WTRU determines a CSI based on a first CSI-RS resource for a first SRS port group, the WTRU may also determine interference at the second SRS port group based on the first CSI-RS resource.

The WTRU may determine the CSI of one or more groups based on a configured, indicated, or other (e.g., fixed) criteria, e.g., to maximize capacity offered by the SRS port grouping wireless channel, to minimize interference between the SRS port groups, to minimize interference to one or more groups, to minimize interference to the primary groups, etc.

Examples are described herein for differential CSI for multiple SRS port groups. The WTRU may determine the CSI of SRS port groups other than the primary SRS port group(s) based on the CSI of the primary SRS port group. For example, the WTRU may determine a first CSI for the first SRS port group, where the first SRS port group may be the primary SRS port group. The WTRU may determine a second CSI for the second SRS port group, where the second SRS port group is not the primary SRS port group. The CSI determined for the second group may be based on CSI of the first SRS port group and/or one or more configured, fixed, or indicated set of offset values.

In an example, the WTRU may determine a precoder from a codebook of precoders for a first SRS port group, e.g., the index of the determined or selected precoder is i in the codebook of precoders. The WTRU may determine a precoder for the second SRS port group based on precoder with index i and a set of offset values, e.g., set S. The set S may include one or more precoders in the codebook associated with the second SRS port group. For example, the set S may include (e.g., all) precoders that are orthogonal to the precoder i selected for the first SRS port group.

In an example, the WTRU may determine a CQI for a first SRS port group, e.g., the CQI of the first SRS port group is j. The WTRU may determine a CQI for the second SRS port group based on the CQI of the first group j, e.g., g=j+p, where p may range from −x, . . . , 0, . . . , x (e.g., x=5). The value of x may be semi-statically or dynamically configured. The range of p may also be semi-statically or dynamically configured.

In an example, the WTRU may determine a wideband CSI, e.g., wideband CQI for a first SRS port group. The determined wideband CSI a reference for sub-band CSI determination for a second SRS port group, e.g., the wideband CQI of the first group is a reference for the sub-band CQI on the second group.

Examples are described herein for layer to SRS port groups map or codeword mapping. For example, layers to codewords mapping or layers to SRS port groups mapping for one or two codewords may be defined in a variety of ways.

The mapping may be pre-defined as fixed layers to codewords mapping. For example, the first layer is mapped to the first SRS port group and the second layer is mapped to the second SRS port group. For example, the first 2 layers are mapped to the first SRS group and the remaining 3 layers are mapped to the second SRS group

In a solution, when fixed layer mapping is defined or configured, for example, the first 4 layers may be associated with the first SRS port group and the second the remaining layers may be associated with the second SRS port group. When fixed codewords to SRS port groups or codewords to layer mapping are defined, e.g., the first 4 layers may be for the first SRS port group or the first codeword. In an example where the WTRU determines and reports a rank value (e.g., RI=4), the WTRU may assume that the gNB may schedule (e.g., only schedule) a single codeword transmission, and the WTRU may use the SRS port group associated with the (e.g., single) codeword. The WTRU may also use other SRS port groups along with the port group associated with the codeword for reception of the codeword.

The mapping may be based on an association rule. The association rule may include one or more of the determined CSIs. For example, the association may be defined based on the rank value RI. For example, when the WTRU reports RI=8, the first 4 layers may be associated with a first codeword and the second 4 layers may be associated with a second codeword. As another example, when the WTRU reports RI=4, the first 2 layers may be associated with a first codeword and the second 2 layers may be associated with a second codeword.

Examples are described herein for CSI reporting. The WTRU may send a CSI report to report the determined CSIs (e.g., the determined CSIs for each SRS port group) to the gNB using a scheduled uplink transmission (e.g., a scheduled PUSCH or Physical Uplink Control Channel (PUCCH)).

The WTRU may report the determined CSIs (e.g., the CSIs determined for all the SRS port groups) in one or more CSI reports. By way of example, the WTRU may determine CSIs for three SRS port groups. In this example, the WTRU may report (e.g., Mode 1) the determined CSIs based on a single CSI report (i.e., CSIs of all groups in one report), (e.g., Mode 2) two CSI reports (i.e., the CSI of the first group and the second group in a first report and the CSI of the third group in a second CSI report), (e.g. Mode 3) three CSI reports (i.e., the CSI of each group is reported in a separate CSI report).

A single CSI report may have two or more portions, sections or parts (e.g., CSI part 1 and CSI part 2). The WTRU may determine where to place or report the determined CSIs (e.g., CQI1, PMI1, RI1 associated with first group and CQI2, PMI2, RI2 associated with a second group) in the CSI report(s) based on the number of CSI reports and/or the number of SRS port groups. For example, when the so-called Mode1, Mode2, or Mode3 reporting behavior is configured, the WTRU may place (e.g., order) the CSIs based on the configured Mode.

For example, when Mode1 is configured, a single CSI report may have three parts. In this example, the CSIs may be placed in the various parts of the CSI report, e.g., CSI associated with a first SRS port group is in the first part of the CSI report, CSI associated with a second SRS port group is in the second part of the CSI report, and CSI associated with a third SRS port group is in the third part of the CSI report.

As another example, when Mode2 is configured, the first CSI report may have three parts. In this example, CSIs may be placed in the parts, e.g., high priority CSI associated with a first SRS port group may be in the first part of the CSI report, low priority CSI associated with the first SRS port group may be in the second part of the CSI report, and CSI associated with a second SRS port group may be in the third part of the CSI report.

One or more parts of one or more CSI reports may be associated with a transmission priority, e.g., a high or a low priority. CSI contents placed in the various parts of the CSI report may have the same transmission priority as the transmission priority associated with the CSI part. For example, a first part of a CSI report may have the highest priority. Thus, when the CSI of a second SRS port group is placed in the first part of the CSI report, the CSI of the second SRS port groups becomes the highest priority CSI. The WTRU may be semi-statically or dynamically configured and/or indicated an association of CSI parts and SRS port groups. For example, the WTRU may receive a DCI with a field indicating that the CSI of the third group should be in the first part of the second CSI report.

The WTRU may prioritize or de-prioritize the reporting of one or more CSI parts over one or more other CSI parts of the same and/or different CSI report. For example, the WTRU may prioritize the reporting of CSI part 1 of a first CSI report over the CSI reporting of part 2 of the same CSI report. As another example, the WTRU may prioritize the entire first CSI report over the second CSI report.

By association of receive antenna ports to SRS groups, CSI-RS ports may become associated to SRS port-group as well. In some applications, when CSI report quantity cri-RI-CQI is configured, CSI-RS ports may be configured via the field non-PMI-PortIndication. This mechanism may support a fixed assignment of CSI-RS ports for each rank. For example, for a total configured CSI-RS ports of 8 (i.e., {0, 1, 2, 3, 4, 5, 6, 7}), the ports may be assigned to Rank as follows.

Rank 1: Port {0} associated to a first CW.

Rank 2: Ports {0, 1} associated to the first CW.

Rank 3: Ports {0, 1, 2} associated to the first CW.

Rank 4: Ports {0, 1, 2, 3} associated to the first CW.

Rank 5: Ports {0, 1} associated to the first CW, and Port {4, 5, 6} associated to a second CW.

Rank 6: Ports {0, 1, 2} associated to the first CW, and Port {4, 5, 6} associated to the second CW.

Rank 7: Ports {0, 1, 2} associated to the first CW, and Port {4, 5, 6, 7} associated to the second CW.

Rank 8: Ports {0, 1, 3, 4} associated to the first CW, and Port {4, 5, 6, 7} associated to the second CW.

In the example above, due to variation of channel corresponding to each port-group, a fixed mapping of CSI-RS port may be less efficient. In some scenarios, such variation may have an impact on performance (e.g., especially for rank 5 and 7). For example, where the following CSI-RS port mapping is for Rank 7.

Rank 7: Ports {0, 1, 2} associated to the first CW, and Port {4, 5, 6, 7} associated to the second CW.

In this scenario, as long as the channel corresponding to the first and second port-group support a rank of 3 and 4, respectively, there may not be an issue with performance. However, consider a scenario where the gNB determines (e.g., based on an SRS transmission) that the total rank has remained 7 for example and the rank corresponding to each of the first and second port-groups has changed to 4 and 3 respectively for example. In this example (Option A), the gNB may schedule a rank 6 transmission so that the rank of the transmission does not contradict the rank of the channel for each port-group. However, in some cases, doing so may reduce the spectrum efficiency of the system. In an alternative example (Option B), the gNB may continue to schedule a rank 7 according to the existing CSI-RS port mapping. However, in this case, the decoding of the first CW may fail (e.g., and/or may likely fail). In an alternative example (Option C), the gNB may dynamically re-shuffle the CSI-RS port mapping so that each subset of CSI-ports becomes associated to a correct CW. For instance, the CSI-RS port mapping may be re-organized (e.g., updated) as follows.

Rank 7: Ports {0, 1, 2, 3} associated to the second CW, and Port {4, 5, 6} associated to the first CW.

Therefore, with Option C, there may not be any mis-match (e.g., or there may be less mis-match) between the CSI-RS port mapping and the actual rank of the channel corresponding to each port-group.

In various examples, the WTRU may receive an indication of (e.g., dynamically indicated) a CSI-RS port mapping for one or more rank in a variety of ways.

In a solution, the WTRU may receive a dynamic indication to switch between assignments of configured CSI-RS ports to each CW. For example, the WTRU may receive a single bit to toggle the configured port assignments between the port groups. For example, when a bit value of 0 is indicated, the WTRU may use an RRC configured and/or current mapping. On the other hand, if a bit value of 1 is indicated, the WTRU may swap the CSI port mapping between the CWs. In another solution, the WTRU may be configured (e.g., via an RRC) with multiple CSI-RS port mapping to codewords for at least one rank. For example, the WTRU may receive a (e.g., dynamic) indication (e.g., a MAC CE, scheduling DCI, etc.) to select one of the configured CSI-RS port mapping. In another solution, the WTRU may receive a dynamic indication for CSI-RS port update for only a subset of ranks (e.g., Rank 5, Rank 7, etc.).

Examples are described herein for priority of port groups for reception. The WTRU may receive an indication (e.g., a scheduling DCI) from which the WTRU may determine the associated antenna ports for reception of the scheduled transmission. For example, the WTRU may determine a codeword to be processed by antenna ports associated to the first port-group, the second port-group, or both of the first and second port groups.

Examples are described herein for a WTRU determining the SRS port group associated per CW. By way of example, the WTRU may (e.g., dynamically) receive in a DCI the association between a port group and a CW. For example, the DCI may include a field to indicate the number of scheduled CWs, and a field indicating the port group associated per indicated CW. For example, the WTRU may receive a DCI with 2 CWs scheduled. In this example, a DCI field may indicate that the WTRU is to receive a first code word (e.g., CW1) with the first port group and a second codeword (e.g., CW2) with the second port group.

The WTRU may determine that all transmission parameters associated with a port group (e.g., PMI, RI, MCS) may be used to decode a CW that is associated with a port group. If the WTRU is scheduled with 1CW, for example, the DCI may indicate that both port groups are associated to the same CW. In this case, the WTRU may receive CW1 over both antenna port groups and may decode a single CW using transmission parameters from both port groups.

Examples are described herein for a WTRU determining SRS port group(s) associated per CW. In one solution, the WTRU may be configured with a different Transmission Configuration Indicator (TCI) state per SRS port group. The TCI state indicates the spatial filter that the WTRU should use to receive a transmission per port group. The TCI state may be a fixed association to the CW. For example, if the WTRU is scheduled with one CW, the WTRU may determine that the TCI state of the first port group is used for the first CW. If the WTRU is scheduled with two CWs, the WTRU may determine that the TCI state of the first and second port groups are used for the first and second CWs, respectively. The TCI state per port group may be separately activated and/or deactivated through, for example, a MAC-CE which indicates the TCI states per port group.

Alternatively, a scheduling grant (e.g., DCI) may include an explicit indication of TCI state association to CWs. For example, the DCI may include a TCI codepoint which is configured with two TCI states. The WTRU may receive the DCI, and determine that the first of the two TCI states is associated to CW1 (e.g., port group 1) and the second TCI state is associated to CW2 (e.g., port group 2).

If no TCI state is indicated in the DCI, the WTRU may be configured with a rule for selecting a default TCI state per port group. For example, the WTRU may determine to use the same TCI state used to receive a Physical Downlink Control Channel (PDCCH) and apply it to both CWs. Alternatively, two different TCI states may be configured, and the WTRU may determine the default TCI state per CW based on the TCI state of the SRS port group associated per CW.

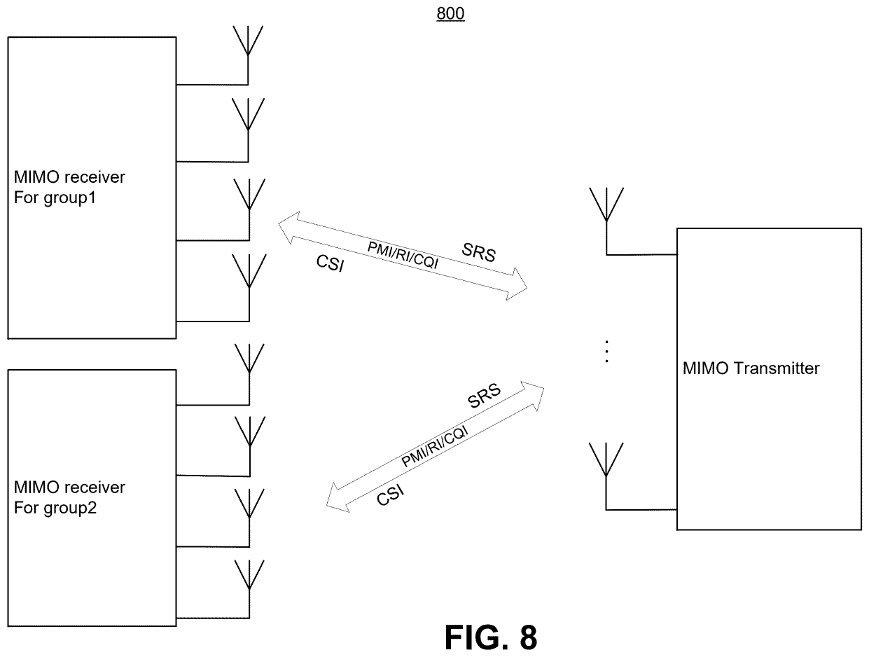

FIG. 8 is a block diagram 800 illustrating an example of SRS port grouping according to an embodiment. Based on a SRS port-grouping scheme, a codebook precoding procedure between UE and gNB may be configured in accordance with the example of FIG. 8 and in line with the discussion below.

For example, a WTRU with 8 Rx ports may report its capability for the support of SRS port-grouping. For example, the WTRU may report that N_{G}=2 groups are supported where each group has 4 Rx ports for receiving, e.g., 4 ports in the first group and the other 4 ports in the second group as shown in FIG. 8. The WTRU may also report one or more other (e.g., all) combinations of supported N_{G} and supported ports in each group. The WTRU may then receive a CSI configuration. Then, based on the reported WTRU capability, the WTRU may receive a value for N_{G} and an indication of one of the supporting ports combinations. The WTRU may then determine one report for the first port group (e.g., PMI1, RI1, CQI1) and one report for the second port group (e.g., PMI2, RI2, CQI2). Then the UE may either separately or jointly determine PMI1 and PMI2 to minimize the interference, for example, as set forth in the equation below.

$$Reported PMI = [ \begin{matrix}PMI 1 & 0 \\ 0 & Φ PMI 2\end{matrix} ] .$$

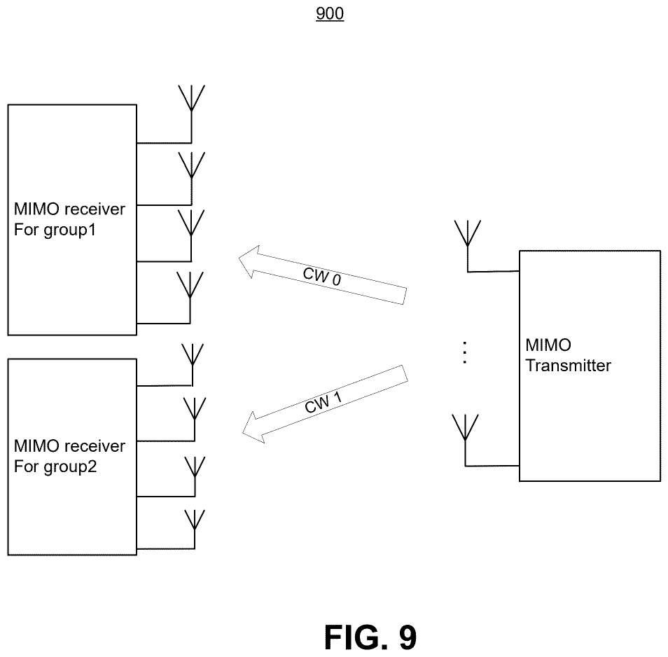

FIG. 9 is a block diagram 900 illustrating an example of codebook-based downlink (DL) transmission with SRS port grouping according to an embodiment. Continuing with the example above, as shown in FIG. 9, the WTRU may receive one CW for each port group.

1. A wireless transmit/receive unit (WTRU) comprising:
a processor configured to:
send a report indicating sounding reference signal (SRS) port grouping capability of the WTRU;
receive an indication of at least a first SRS port group and a second SRS port group, wherein each of the first SRS port group and the second SRS port group is associated with a respective subset of antenna ports;
estimate a first channel state information (CSI) for the first SRS port group and a second CSI for the second SRS port group;
send one or more CSI reports indicating the first estimated CSI and the second estimated CSI; and
receive configuration information indicating a codeword (CW) for processing a scheduled transmission using antenna ports of at least one of the first SRS port group or the second SRS port group.

2. The WTRU of claim 1, wherein the processor is further configured to:
receive an indication to trigger CSI reporting; and
estimate the first CSI and the second CSI in response to receiving the indication to trigger CSI reporting.

3. The WTRU of claim 1, wherein the processor is further configured to:
estimate the first CSI and the second CSI according to a first estimation mode and a second estimation mode; and
send the one or more CSI reports to indicate, for each of the first estimation mode and the second estimation mode, the first CSI and the second CSI.

4. The WTRU of claim 3, wherein the processor, to estimate the first CSI and the second CSI in the first estimation mode, is further configured to:
determine the first CSI based on a measurement performed on a first subset of the antenna ports corresponding to the first SRS port group; and
determine the second CSI based on a measurement performed on a second subset of the antenna ports corresponding to the second SRS port group, and
wherein the processor, to estimate the first CSI and the second CSI in the second estimate mode, is further configured to:
determine the first CSI and the second CSI based on a joint measurement performed on the antenna ports corresponding to both of the first SRS port group and the second SRS port group.

5. (canceled)

6. The WTRU of claim 3, wherein the processor, to send the one or more CSI reports, is further configured to:
receive an indication to trigger CSI reporting and a priority for CSI reporting associated with each of the first SRS port group and the second SRS port group; and
based on the first SRS port group having a higher priority than the second SRS port group, send a first CSI report corresponding to the first SRS port group prior to a second CSI report corresponding to the second SRS port group.

7. The WTRU of claim 1, wherein the processor is further configured to:
based on the report indicating that the WTRU supports a plurality of port grouping configurations, receive an indication of a recommended port grouping configuration; and
based on the recommended port grouping configuration, select the first SRS port group and the second SRS port group and the respective subset of the antenna ports of each of the first SRS port group and the second SRS port group.

8. The WTRU of claim 1, wherein the processor is further configured to:
based on the received indication of the first SRS port group and the second SRS port group, determine the respective subsets of the antenna ports assigned to each of the first SRS port group and the second SRS port group.

9. The WTRU of claim 1, wherein the processor is further configured to:
receive, via radio resource control (RRC), the indication of the first SRS port group and the second SRS port group.

10. The WTRU of claim 1, wherein the first CSI and the second CSI include at least one of a precoding matrix indicator (PMI), a rank indicator (RI), a channel quality indicator (CQI), or a layer indicator (LI).

11. A method performed by a wireless transmit/receive unit (WTRU), the method comprising:
sending a report indicating sounding reference signal (SRS) port grouping capability of the WTRU;
receiving an indication of at least a first SRS port group and a second SRS port group, wherein each of the first SRS port group and the second SRS port group is associated with a respective subset of antenna ports;
estimating a first channel state information (CSI) for the first SRS port group and a second CSI for the second SRS port group;
sending one or more CSI reports indicating the first estimated CSI and the second estimated CSI; and
receiving configuration information indicating a codeword (CW) for processing a scheduled transmission using antenna ports of at least one of the first SRS port group or the second SRS port group.

12. The method of claim 11, further comprising:
receiving an indication to trigger CSI reporting; and
estimating the first CSI and the second CSI in response to receiving the indication to trigger CSI reporting.

13. The method of claim 11, further comprising:
estimating the first CSI and the second CSI according to a first estimation mode and a second estimation mode; and
sending the one or more CSI reports to indicate, for each of the first estimation mode and the second estimation mode, the first CSI and the second CSI.

14. The method of claim 13, wherein estimating the first CSI and the second CSI in the first estimation mode comprises:
determining the first CSI based on a measurement performed on a first subset of the antenna ports corresponding to the first SRS port group; and
determining the second CSI based on a measurement performed on a second subset of the antenna ports corresponding to the second SRS port group, wherein estimating the first CSI and the second CSI in the second estimation mode comprises determining the first CSI and the second CSI based on a joint measurement performed on the antenna ports corresponding to both of the first SRS port group and the second SRS port group.

15. (canceled)

16. The method of claim 13, wherein sending the one or more CSI reports comprises:
receiving an indication to trigger CSI reporting and a priority for CSI reporting associated with each of the first SRS port group and the second SRS port group; and
based on the first SRS port group having a higher priority than the second SRS port group, sending a first CSI report corresponding to the first SRS port group prior to a second CSI report corresponding to the second SRS port group.

17. The method of claim 11, further comprising:
based on the report indicating that the WTRU supports a plurality of port grouping configurations, receiving an indication of a recommended port grouping configuration; and
based on the recommended port grouping configuration, selecting the first SRS port group and the second SRS port group and the respective subset of the antenna ports of each of the first SRS port group and the second SRS port group.

18. The method of claim 11, further comprising:
based on the received indication of the first SRS port group and the second SRS port group, determine the respective subsets of the antenna ports assigned to each of the first SRS port group and the second SRS port group.

19. The method of claim 11, further comprising:
receiving, via radio resource control (RRC), the indication of the first SRS port group and the second SRS port group.

20. The method of claim 11, wherein the first CSI and the second CSI include at least one of a precoding matrix indicator (PMI), a rank indicator (RI), a channel quality indicator (CQI), or a layer indicator (LI).

21. The WTRU of claim 1, wherein a first codeword (CW) is associated with the first SRS port group and a second CW is associated with the second SRS port group.

22. The method of claim 11, wherein a first codeword (CW) is associated with the first SRS port group and a second CW is associated with the second SRS port group.
